(19) United States
(12) Patent Application Publication
(10) Pub. No.: US 2019/0342628 A1
(43) Pub. Date: Nov. 7, 2019

(54) COMMUNICATION DEVICE AND METHOD

(71) Applicant: CANON KABUSHIKI KAISHA, Tokyo (JP)

(72) Inventor: Tomoya Sakai, Kawasaki-shi (JP)

(21) Appl. No.: 16/516,420

(22) Filed: Jul. 19, 2019

Related U.S. Application Data
(63) Continuation of application No. PCT/JP2018/000647, filed on Jan. 12, 2018.

(30) Foreign Application Priority Data
Feb. 7, 2017 (JP) 2017-020677

(51) Int. Cl. H04N 21/6547; H04N 21/262; H04N 21/437; H04N 21/435; H04N 21/2662

(52) U.S. Cl. CPC H04N 21/6547; H04N 21/26258; H04N 21/2662; H04N 21/435; H04N 21/437

(57) ABSTRACT

A communication device that transmits notification information to be referred to by a client to request a video to the client, generates the notification information, in which a group of sets is expressed using an identifier common in information pertaining to the group of sets, among a plurality of sets including a first set corresponding to a first plurality of videos having different quality ranks and a second set corresponding to a second plurality of videos having different quality ranks, that has common settings pertaining to a difference between the quality ranks, and information indicating settings, for each group of sets, pertaining to a difference between the quality ranks for a plurality of videos to be transmitted to the client; and transmits the generated notification information to the client.

### CROSS-REFERENCE TO RELATED APPLICATIONS

This application is a continuation of International Patent Application No. PCT/JP2018/000647 filed on Jan. 12, 2018, which claims priority to and the benefit of Japanese Patent Application No. 2017-020677, filed Feb. 7, 2017, the entire disclosures of which are incorporated herein by reference.

### BACKGROUND OF THE INVENTION

### Field of the Invention

The present invention relates to a communication device, and a method, and particularly relates to a media data streaming technique.

### Background Art

Systems that transmit streaming content including audio, video, and the like to the terminal devices of users in real time are being provided in recent years. Such a system allows a user to enjoy his or her desired content, such as live video or the like, in real time through his or her own terminal device.

Techniques for dynamically changing the stream being obtained in accordance with the performance of the terminal device, the communication environment in which the terminal device is located, and the like are attracting attention (MPEG-DASH, Http Live Streaming, and the like). According to these techniques, video is divided into fine time-based segments, and URLs (Uniform Resource Locators) for obtaining the segments are written in a file called a “playlist”. The terminal device obtains the playlist and uses the information written in the playlist to acquire the desired video. URLs for video segments having multiple versions are written in a playlist, and the terminal device can obtain the video segments having the optimal version in accordance with the performance of the device, the communication environment, and the like.

Incidentally, rather than dividing video into time-based segments, video can be divided into multiple videos by dividing pictures within the videos into multiple pixel regions. Japanese Patent Laid-Open No. 2015-061316 discloses a method for dividing a single picture in a video, encoding the divisions as multiple regions that can be decoded independently, and transmitting the regions using MPEG-DASH.

However, if multiple videos corresponding to multiple pixel regions are obtained at mutually-different qualities, there is a risk that, depending on the differences in quality among the multiple videos, the quality of the one video displayed on the basis of the multiple videos will be insufficient. For example, when a single video is displayed on the basis of videos corresponding to three vertical×three horizontal, for a total of nine, regions, if the quality is high in the central region and significantly lower in the other regions, a viewer may feel that the quality of the video as a whole is insufficient.

### CITATION LIST

### Patent Literature

Patent Document 1: Japanese Patent Laid-Open No. 2015-061316

### SUMMARY OF THE INVENTION

The present invention prevents a situation in which differences in quality among a plurality of regions cause an overall video to give the impression of low quality, in a system that can obtain video at different qualities corresponding to a plurality of regions.

A communication device according to one aspect of the present invention is a communication device that transmits notification information to be referred to by a client to request a video to the client, and includes: a generating unit configured to generate the notification information, in which a group of sets is expressed using an identifier common in information pertaining to the group of sets, among a plurality of sets including a first set corresponding to a first plurality of videos having different quality ranks and a second set corresponding to a second plurality of videos having different quality ranks, that has common settings pertaining to a difference between the quality ranks, and information indicating settings, for each group of sets, pertaining to a difference between the quality ranks for a plurality of videos to be transmitted to the client; and a transmitting unit configured to transmit the notification information generated by the generating unit to the client.

Further features of the present invention will become apparent from the following description of exemplary embodiments with reference to the attached drawings.

### BRIEF DESCRIPTION OF THE DRAWINGS

The appended drawings, which are included in and constitute part of the specification, illustrate embodiments of the present invention, and along with those descriptions serve to illustrate the principles of the present invention.

FIG. 1 is a diagram illustrating an example of the configuration of a communication system.

FIG. 2A is a diagram illustrating an example of the tiling and classification of a video.

FIG. 2B is a diagram illustrating an example of the tiling and classification of a video.

FIG. 2C is a diagram illustrating an example of the tiling and classification of a video.

FIG. 2D is a diagram illustrating an example of the tiling and classification of a video.

FIG. 2E is a diagram illustrating an example of the tiling and classification of a video.

FIG. 3 is a diagram illustrating an overview of a process through which a client obtains tiles.

FIG. 4 is a block diagram illustrating an example of the hardware configuration of a server.

FIG. 5 is a block diagram illustrating an example of the functional configuration of the server.

FIG. 6 is a block diagram illustrating an example of the hardware configuration of a client.

FIG. 7 is a block diagram illustrating an example of the functional configuration of the client.

FIG. 8 is a diagram illustrating an example of the content of an MPEG-DASH MPD file.

FIG. 9 is a diagram illustrating an example of the content of an MPEG-DASH MPD file.

FIG. 10 is a diagram illustrating an example of the content of an MPEG-DASH MPD file.

FIG. 11 is a diagram illustrating an example of the content of an MPEG-DASH MPD file.

FIG. 12A is a flowchart illustrating an example of the flow of processing executed by the server.

FIG. 12B is a flowchart illustrating an example of the flow of processing executed by the server.

FIG. 13 is a flowchart illustrating an example of the flow of processing executed by the client.

### DESCRIPTION OF THE EMBODIMENTS

Embodiments of the present invention will be described hereinafter with reference to the drawings. Note that the following embodiments are not intended to limit the scope of the present invention. The configurations described in the following embodiments may be at least partially omitted, and additional constituent elements may be added as well. The sequences of the methods described in the embodiments may be changed. Some of the steps may be omitted, and additional steps may be used as well.

### System Configuration

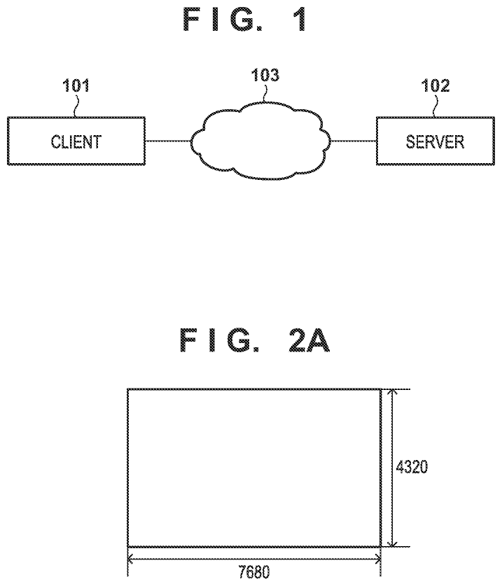

FIG. 1 illustrates an example of the configuration of a communication system according to the present embodiment. According to this example, the communication system includes a client 101 and a server 102, and the client 101 and the server 102 are connected to each other over a network 103. The client 101 and the server 102 may, however, be connected to each other directly, without using the network 103. For example, the client 101 and the server 102 may communicate directly by forming a wireless ad-hoc network.

The client 101 is a communication device having a display function, such as a DTV (Digital TV), an HMD (Head Mounted Display), a smartphone, a tablet, a personal computer (PC) with a built-in display, or the like. However, the client 101 does not absolutely have to be configured as a device, and may also be a web browser or another application installed in various types of devices such as those mentioned here. Likewise, the client 101 does not absolutely have to have a display function, and may be a projector having a projection device, a PC capable of displaying information in an external display, or the like. The client 101 may be a multi-projector having a plurality of projection devices. The client 101 may furthermore be an intermediate device that relays communication within a communication path between an information display device and the server 102, such as a proxy device, a device included in a CDN (Contents Deliver Network), or the like.

The server 102 is, for example, a digital camera, a digital video camera, a network camera, a projector, a mobile phone, a smartphone, a PC, a generic server device, and the like, and is a communication device capable of functioning as a server device from which video data is transmitted. Although the server 102 is shown as a single device in the example illustrated in FIG. 1, the functions of the server 102 may be distributed among and executed by a plurality of devices arranged throughout the cloud, for example.

The network 103 is a communication network that connects the client 101 and the server 102, and signals transmitted by these devices are transferred by the network 103 and received by other devices. The network 103 is any desired network, such as the internet or an intranet, a wired network or a wireless network, or the like, for example. The network 103 can be a network that combines various types of interfaces, such as being a wired network in some locations and a wireless network in others. The wireless network can use any desired wireless communication interface, including a public wireless network such as the 3GPP LTE, wireless LAN compliant with the IEEE 802.11 standard, Bluetooth (registered trademark), or the like. 3GPP is an acronym for 3rd Generation Partnership Project, and LTE is an acronym for Long Term Evolution. IEEE is an acronym for Institute of Electrical and Electronics Engineers. An interface based on the Ethernet (registered trademark) standard, for example, can be used for the wired network, but any other desired interface may be used. The network 103 may also have any desired scale, such as a LAN (Local Area Network), a WAN (Wide Area Network), or the like.

In the communication system according to the present embodiment, the client 101 can obtain a video divided into a plurality of pixel regions and play back a single video. The pixel regions resulting from the division will be called “tiles” below. In other words, a “tile” corresponds to a partial region of the video that will ultimately be played back. Note also that in the present embodiment, the “video” may be data in which the frames (pictures) included therein are compressed as individual still images, data in which each frame is compressed as a moving image, or data that is not compressed.

A plurality of videos, each corresponding to a different quality, are present for each of the tiles, and the client 101 obtains a single video from a set of that plurality of videos. The client 101 then acquires one video each from a plurality of sets including at least a first set related to a first plurality of videos and a second set related to a second plurality of videos, and concatenates the obtained videos to play back a single video. The server 102 communicates a list of the plurality of videos included in each of the plurality of sets to the client 101. At this time, the list can include information such as the location of each of the plurality of videos included in each of the plurality of sets (a URL (Uniform Resource Locator) or the like indicating from where the video is obtained).

In the present embodiment, information of settings pertaining to differences in quality among the plurality of sets is communicated in order to prevent differences in quality among a plurality of tiles from imparting a sense of unnaturalness on the viewer. Here, the information of settings pertaining to differences in quality can, for example, the information indicating that it is recommended for the difference in quality among the plurality of sets to be within a given range, or information indicating that the difference in quality among the plurality of sets may be any difference. The information of settings pertaining to the difference in quality may also be information indicating that it is necessary for a maximum value of the difference in quality among the plurality of sets to be within a predetermined range. Thus, for example, notifying the client 101 of a setting indicating that the difference in quality among the plurality of sets should be reduced ensures that the client 101 does not obtain video in which the quality varies drastically from tile to tile. This makes it possible to prevent a sense of unnaturalness from being imparted on the viewer, such as in a situation where one tile has a high level of quality but another tile has a very low level of quality. On the other hand, the client 101 can be notified of a setting indicating that the difference in quality is inconsequential for video where the viewer is unlikely to experience a sense of unnaturalness even if the difference in quality is high, such as video in which the same scene is shown in all pixel regions, for example.

Here, a situation is possible in which it is better to handle different regions in a single video in different ways, such as when the viewer has different sensitivities with respect to differences in quality due to, for example, the relationship between pixel regions in the background and pixel regions in the foreground which the viewer focuses on. As such, in the present embodiment, the aforementioned plurality of sets are classified into collections of sets (set groups) that share the same settings with respect to differences in quality, and the information indicating the settings for each collection is communicated to the client 101. Next, an overview of processing according to the present embodiment will be given, after which the configurations of the client 101 and the server 102, and the flow of processing executed thereby, will be described.

### Overview of Processing

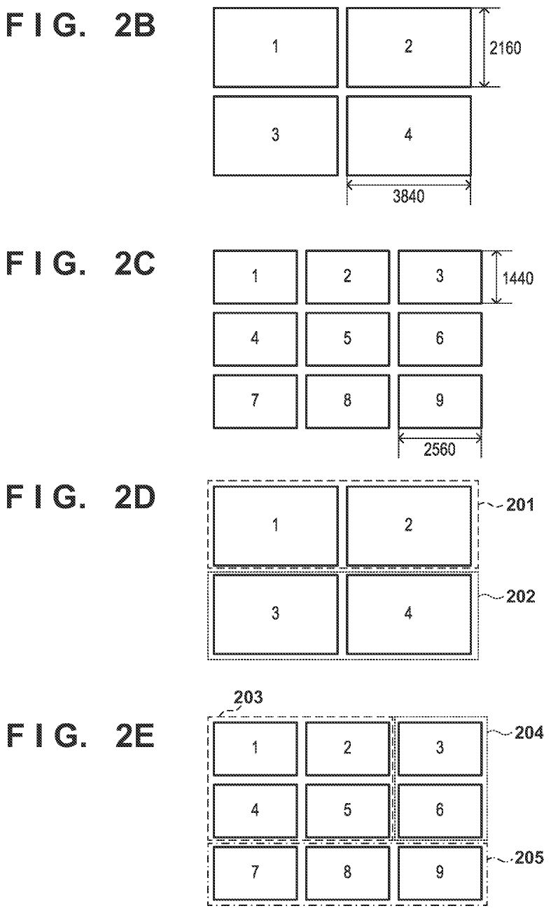

First, an example of the tiling of a video and the classification of tiles will be described using FIGS. 2A to 2E. FIG. 2A illustrates a picture at a given time in a video having 7,680 horizontal pixels and 4,320 vertical pixels. FIG. 2B illustrates the picture in FIG. 2A having been divided into four tiles by being divided into two equal parts in the width direction and the height direction. In the state illustrated in FIG. 2B, each tile has a size that is 7,680/2=3,840 pixels in the width direction and 4,320/2=2,160 pixels in the height direction. FIG. 2C illustrates the picture in FIG. 2A having been divided into nine tiles by being divided into three equal parts in the width direction and the height direction. In the state illustrated in FIG. 2C, each tile has a size that is 7,680/3=2,560 pixels in the width direction and 4,320/3=1,440 pixels in the height direction.

In the present embodiment, the picture illustrated in FIG. 2A is divided into tiles having equal sizes as described above, but this is merely an example, and the method for dividing into tiles is not limited thereto. The following discussion is applicable even when the obtained tiles do not have uniform sizes, such as when, for example, the picture is divided into 3×3 tiles with the tile in the center having a larger size and the tiles in the periphery thereof having a smaller size.

FIG. 2D illustrates the tiles obtained by the division indicated in FIG. 2B having been classified into a collection 201, which is constituted by tile 1 and tile 2, and collection 202, which is constituted by tile 3 and tile 4. FIG. 2E illustrates the tiles obtained by the classification indicated in FIG. 2C having been divided into three collections. In FIG. 2E, the nine tiles are classified into a first collection 203 (a first set group 203), which is constituted by tile 1, tile 2, tile 4, and tile 5, a second collection 204 (a second set group 204), which is constituted by tile 3 and tile 6, and a third collection 205 (a third set group 205), which is constituted by tile 7, tile 8, and tile 9.

In the examples illustrated in FIG. 2D and FIG. 2E, adjacent tiles are classified into the same collection, but the classification is not limited thereto. For example, non-adjacent tiles may be classified into a single collection, such as tile 1, tile 5, and tile 9 in FIG. 2E. Additionally, all of the tiles may be classified into a single collection (i.e., not classified at all).

Note that the video encoding method is not particularly limited in the present embodiment. For example, although the video encoding method may be HEVC (High Efficiency Video Coding), AVC (Advanced Video Coding), VP8, or VP9, another video encoding method may be used instead. Additionally, the encoding of video divided into tiles may be carried out individually for each of the individual tiles, or may be carried out across a plurality of tiles. Furthermore, LHEVC (Layered HEVC), SVC (Scalable Video Coding), MVC (Multiview Video Coding), or another type of scalable encoding method or layered encoding method may be used. When using layered encoding, the number of layers may be two or more. A combination of layering and tiling may be applied as well. For example, video may be used in which a low-quality base layer is not tiled but a high-quality enhancement layer is tiled.

The video that has undergone the encoding process is stored in a video container. The video container format can be ISO BMFF, HEVC File Format, MPEG2-TS, Common Media Application Format, or WebM, for example, but another format may be used as well. ISO is an acronym for International Organization for Standardization, and BMFF is an acronym for Base Media File Format. When being stored in the container format, the video is subjected to segmenting, which divides the video into a plurality of files in the time direction. In the present embodiment, the video stored in the server 102 (or another device) can be segmented into a plurality of files, but the video is not limited thereto, and may be stored as a single file without being segmented. If the video is stored in the server 102 (or another device) as a single file, the client 101 can obtain a segment by specifying a specific range (byte range) of that file.

The following descriptions will assume that MPD (Media Presentation Description), defined by MPEG-DASH, is used for a manifest file. Note that another protocol that uses a playlist description, such as Http Livestreaming or Smooth Streaming, may be used instead of MPEG-DASH.

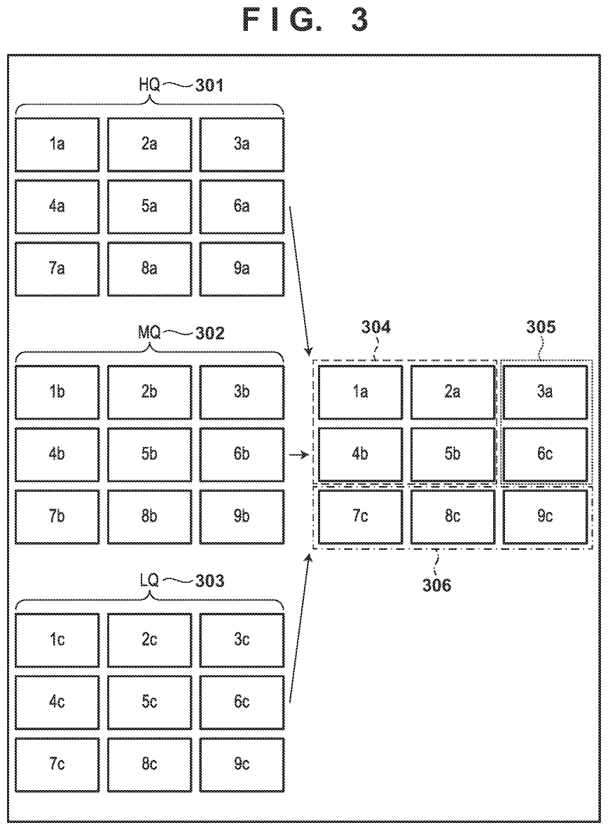

Next, an example of a case where the client 101 obtains and plays back a video classified after being divided into tiles, as illustrated in FIG. 2E, will be described using FIG. 3. Note that the video obtained by the client 101 may have different quality ranks depending on the tile. “Quality rank” as mentioned here can be an evaluation value that takes on a higher value as values such as bitrate, resolution, and sampling rate increase. The quality rank may be determined in any manner on the basis of any desired benchmarks aside from bitrate, resolution, and sampling rate, as long as a ranking can be established on the basis of the superiority/inferiority thereof.

In the example illustrated in FIG. 3, a video having three different quality ranks is prepared, including high-quality (HQ) tiles 301, middle-quality (MQ) tiles 302, and low-quality (LQ) tiles 303. In the following, the high-quality video will be called “tiles 1a-9a”, the middle-quality video will be called “tiles 1b-9b”, and the low-quality video will be called “tiles 1c-9c”. The following descriptions also assume that the difference in quality rank between high quality and middle quality is 1, the difference in quality rank between middle quality and low quality is 1, and the difference in quality rank between high quality and low quality is 2. In other words, the quality is assumed to be given a rank having one of three levels. The video for each tile is generated as a bitstream for each quality rank.

The server 102 communicates, to the client 101, a list of a plurality of videos corresponding to a plurality of quality ranks for each of the plurality of tiles, information indicating the collections of classified tiles, and information of settings pertaining to differences in the quality ranks in each of the collections, for example. The information indicating the collections of the tiles is, for example, information indicating to which of the above-described first collection 203 to third collection 205 (first set group 203 to third set group 205) each of the tiles belongs. Additionally, the settings pertaining to differences in the quality ranks in each of the collections can, for example, specify a recommended value for the difference between quality ranks for each collection so as not to impart a sense of unnaturalness on the viewer (e.g., a difference estimated through experimentation or the like to impart little sense of unnaturalness). However, the settings are not limited thereto, and settings may be made for the differences in the quality ranks using a desired benchmark, such as specifying a value for a difference in the quality rank that does not permit a video to be played back unless the settings designated in each collection are satisfied, for example. The notification method will be described in detail later.

The client 101 plays back the video in accordance with the notified information. The client 101 can determine which of the tiles should be obtained on the basis of the communication environment and the like of the client 101 itself. For example, the client 101 can obtain high-quality video when in a situation where high-speed communication is possible. However, depending on the settings pertaining to the differences in the quality ranks, the client 101 ensures that, when obtaining the video of a given tile, conditions set for the difference between the quality rank of the video to be obtained and the quality rank of the videos of the other tiles included in the same collection are satisfied. Note that if the settings are, for example, desired settings such as recommended settings, the client 101 may obtain video that does not satisfy the conditions set for the difference between the quality ranks of the tiles within the collection. On the other hand, if the settings are, for example, required settings, the client 101 does not obtain video that does not satisfy the conditions set for the difference between the quality ranks of the tiles within the collection. For example, if the maximum value for the difference between the quality ranks of tiles is set to 1 for the first collection 203, the client 101 ensures that the difference between the quality ranks of the videos received for tiles within that collection are no greater than 1. In other words, with the example of the collection 304 in FIG. 3, the client 101 has obtained tile 1a for tile 1, and therefore obtains tile 2a or tile 2b for tile 2, for example. The same applies for tile 4 and tile 5. As such, with the example of the collection 304 in FIG. 3, tile 2a, tile 4b, and tile 5b are obtained in addition to tile 1a. In this manner, of the quality ranks in the collection 304, the highest quality is HQ and the lowest quality is MQ, meaning that the maximum difference between the quality ranks is 1. Note that in this case, if, for example, the client 101 can only obtain tile 5c for tile 5, the tile 1b or tile 1c can be obtained even if the communication state allows for tile 1a to be obtained.

On the other hand, unlike tile 1, tiles 3 and 6 belong to the second collection 204, and thus the client 101 can determine the video that should be obtained for tiles 3 and 6 regardless of the quality class of each tile belonging to the first collection 203. Here, assume that the maximum value for the difference between the quality ranks of the tiles is set to 2 for the second collection 204. As indicated by the collection 305 in FIG. 3, if the client 101 obtains tile 3a for tile 3, the client 101 obtains any one of tile 6a, tile 6b, and tile 6c for tile 6. In other words, in this case, it can be understood that there are no restrictions on the difference between the quality ranks of the tiles for the second collection 204. The example of the collection 305 in FIG. 3 is an example in which tile 3a is obtained for tile 3 and tile 6c is obtained for tile 6. In this manner, the maximum difference between the quality ranks in the collection 305, i.e., the difference between the quality ranks of tile 3 and tile 6, is 2.

Likewise, assume that the maximum value for the difference between the quality ranks of the tiles is set to 2 for the collection 205. In this case, the client 101 ensures that the difference between the highest quality and the lowest quality is within 2 for tile 7, tile 8, and tile 9. In the example of the collection 306 in FIG. 3, it is assumed that tile 7c, tile 8c, and tile 9c are obtained for tile 7, tile 8, and tile 9, respectively. In this case, the highest quality and the lowest quality are both LQ, and thus the maximum difference between the quality ranks is 0.

In this manner, the client 101 can select the video to receive from among sets of videos including pluralities of videos having mutually-different quality ranks for a given tile, taking into account the relationship between the quality rank of the video being received and the quality ranks of the other tiles. At this time, the plurality of tiles are classified, and settings pertaining to differences in the quality ranks are made, which makes it possible to reduce a sense of unnaturalness imparted on the viewer without making unnecessary restrictions from pixel region to pixel region of the video. Although the foregoing describes each tile belonging to only a single collection when the plurality of tiles are classified, the classification is not limited thereto. In other words, some of the tiles, such as tiles at the boundaries of the collections, may be classified so as to belong to two or more collections.

Although FIG. 3 illustrates three levels for the quality ranks, the video is not limited thereto, and video ranked with two levels, or four or more levels, may be prepared as well, for example. Additionally, although FIG. 3 illustrates a state in which videos having three different qualities are prepared for each of the tiles, the tiles are not limited thereto. For example, videos having different numbers of different qualities for each tile may be prepared, such as videos having five different qualities being prepared for tile 1 and video having two different qualities being prepared for tile 2. Furthermore, although the present embodiment describes tiled video as an example, the configuration is not limited thereto. In other words, the following discussions are applicable when playing back a single video obtained by combining videos having a plurality of different qualities, playing back a single piece of audio obtained by combining audio having a plurality of different qualities, and so on. For example, the following discussions are applicable to a method that plays back a plurality of different videos in a single screen, a method that plays back a combination of two videos consisting of a whole video and a partial video cut out from the whole video, or a method that plays back audio data obtained by combining a plurality of pieces of audio. The following discussions are also applicable in a system that plays back a single video by arranging a plurality of videos obtained from a plurality of cameras in a tiled manner, rather than using tiled videos.

### Device Configuration

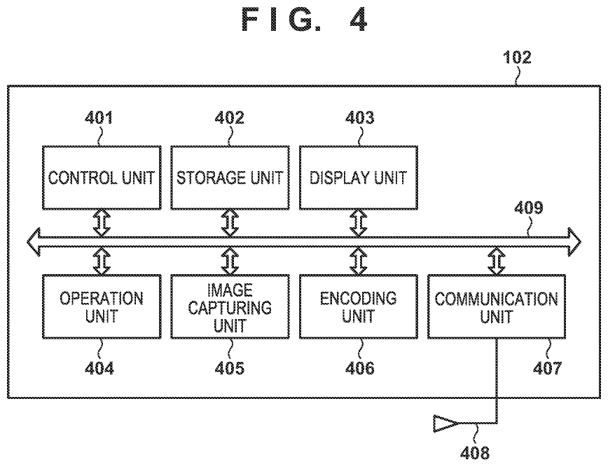

An example of the configuration of the server 102 will be described next. First, an example of the hardware configuration of the server 102 will be described using FIG. 4. The server 102 includes, for example, a control unit 401, a storage unit 402, a display unit 403, an operation unit 404, an image capturing unit 405, an encoding unit 406, a communication unit 407, a wired LAN interface 408, and a system bus 409.

The control unit 401 comprehensively controls the operations of the server 102 by controlling the other constituent elements through the system bus 409, for example. The control unit 401 may be, for example, one or more processors such as a CPU (Central Processing Unit), an ASIC (Application Specific Integrated Circuit), an FPGA (Field Programmable Gate Array), or a DSP (Digital Signal Processor). The storage unit 402 stores and manages various types of data. The storage unit 402 can be memory such as SRAM (Static RAM) or DRAM (Dynamic RAM), a high-capacity storage device such as a hard disk drive, or the like, for example. The display unit 403 is, for example, a liquid crystal panel configured to make various types of displays under the control of the control unit 401. The operation unit 404 is, for example, keys and buttons that accept operations by a user. The display unit 403 and the operation unit 404 may be configured as a single device, as with a touch panel, for example. The image capturing unit 405 captures video. The image capturing unit 405 is configured so as to include lenses, a sensor, and the like, for example. The encoding unit 406 carries out a process for encoding the video. Although the encoding unit 406 may be constituted by a dedicated circuit or the like, the video captured by the image capturing unit 405 may be encoded by the control unit 401 executing a program stored in the storage unit 402, for example. The communication unit 407 executes various types of communication processes through the wired LAN interface 408. The communication unit 407 is configured including communication circuitry such as a modulation/demodulation circuit, for example. The wired LAN interface 408 includes, for example, a photoelectric conversion device, and can convert optical signals received through fiber optics into electrical signals, as well as converting electrical signals into optical signals and transmitting the signals through fiber optics, under the control of the communication unit 407. Although the present embodiment describes the communication unit 407 as employing wired communication, the communication is not limited thereto, and wireless communication may instead be carried out over a wireless LAN, Bluetooth (registered trademark), public mobile communication, or the like. In this case, the wired LAN interface 408 is replaced with an antenna or the like, for example. The server 102 may include a plurality of communication interfaces. Although the present embodiment assumes that the server 102 captures video, the server 102 may instead obtain the video from another communication device.

Although the present embodiment describes using video obtained by a single server device, the configuration is not limited thereto, and the server 102 may generate the video on the basis of data obtained from a plurality of devices. Additionally, the server 102 may obtain video, generated on the basis of data obtained from a plurality of devices, from another device. Although the server 102 includes the encoding unit 406 in the present embodiment, the server 102 may obtain data encoded by another device. Additionally, rather than obtaining the video, the server 102 may instead confirm only the location of the video, and communicate information pertaining to that location to the client 101.

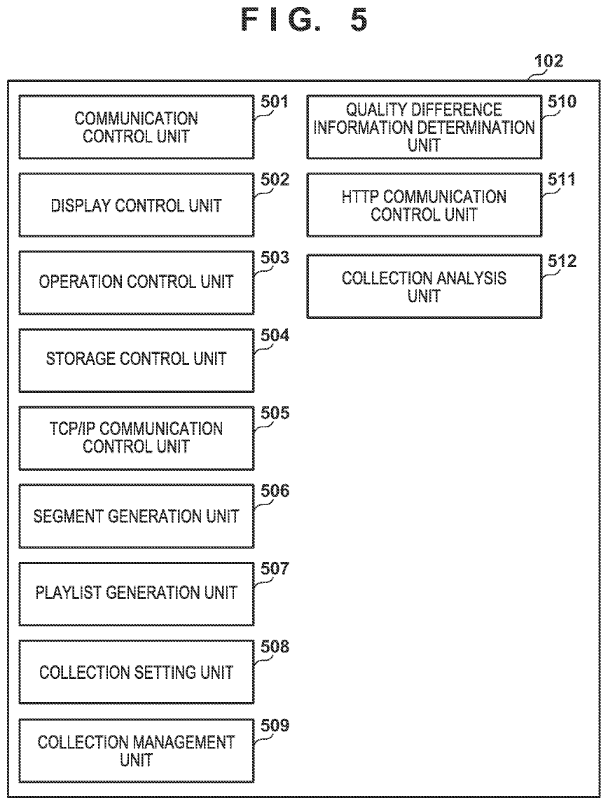

FIG. 5 is a diagram illustrating an example of the functional configuration of the server 102. The server 102 is configured to include, for example, a communication control unit 501, a display control unit 502, an operation control unit 503, a storage control unit 504, a TCP/IP communication control unit 505, a segment generation unit 506, a playlist generation unit 507, and an HTTP communication control unit 511. The server 102 further includes a collection setting unit 508, a collection management unit 509, a quality difference information determination unit 510, and a collection analysis unit 512. The functional units illustrated in FIG. 5 can be realized by, for example, the control unit 401 executing programs stored in the storage unit 402. However, some or all of the functional units, or parts of individual functional units, may be realized by hardware.

The communication control unit 501 controls the communication unit 407 to execute communication. The display control unit 502 controls the display unit 403 to display predetermined information. The display control unit 502 may display a UI for accepting user operations in the display unit 403, for example. The operation control unit 503 controls the operation unit 404 to accept user operations. The storage control unit 504 controls the storage unit 402 to store, change, or delete various types of information. The TCP/IP communication control unit 505 uses the communication unit 407 to control TCP/IP communication with the client 101. Although the present embodiment describes an example in which TCP/IP communication is used, the communication is not limited thereto, and UDP (User Datagram Protocol) may be used instead.

The segment generation unit 506 generates a segment to transmit to the client 101 from a video. Here, the segment generation unit 506 generates a tiled segment. The segment generation unit 506 generates segments having a plurality of different quality ranks for one or more of the tiles. Note that the segment transmitted by the server 102 may be a segment generated by another device.

The playlist generation unit 507 generates a playlist used by the client to obtain video. URLs (Uniform Resource Locators) for accessing specific segments at specific timings are written in the playlist. Here, it is assumed that the playlist is an MPD (Media Presentation Description) file defined by MPEG-DASH, for example. In this case, the URLs of a plurality of videos, each corresponding to one of a plurality of quality ranks for a single tile, are stored in an AdaptationSet element. In other words, the AdaptationSet is an element corresponding to a set of a plurality of videos for a single tile. The playlist generation unit 507 also writes information of the collection to which the AdaptationSet belongs, an identifier of that collection, and information of the settings pertaining to the differences in quality ranks for each AdaptationSet collection in the playlist. For example, in the state illustrated in FIG. 2D, tiles 1 to 4 belong to the collection 201 or 202. Accordingly, information indicating which of the collection 201 and 202 the AdaptationSets pertaining to each tile belongs, identifiers of the collections 201 and 202, and information of the settings pertaining to the differences in quality ranks between the collections 201 and 202, are stored in the MPD file. The information pertaining to the difference between quality ranks is, for example, information indicating the recommended maximum value for the differences in quality ranks, a maximum value for the difference between quality ranks that should be ensured, an indication that there are no restrictions on the difference between quality ranks, or the like, for the corresponding collection. Although the present embodiment describes an example in which the above-described information is written in an MPD file, the file is not limited thereto, and the information may instead be written in an HTML file, a JavaScript file, or the like. The information of the collection to which the AdaptationSet belongs, the collection identifier, and the information of the settings pertaining to the differences in the quality ranks for each AdaptationSet collection may be written in a location aside from an MPD file. For example, the information may be written in an HTML file or a JavaScript file. Note that the information pertaining to the playlist, collection, or the like transmitted by the server 102 may be generated by another device.

The collection setting unit 508 classifies the tiles and sets a collection of tiles. The collection management unit 509 manages information of the collections set by the collection setting unit 508 in association with information of the settings pertaining to the differences in quality determined by the quality difference information determination unit 510. The quality difference information determination unit 510 determines settings for the differences in quality ranks for each collection to which one or more AdaptationSets belong. For example, the quality difference information determination unit 510 can select a magnitude for the difference between quality ranks at which a sense of unnaturalness will not be imparted on the viewer, and take that as the setting value pertaining to the difference between quality ranks. The HTTP communication control unit 511 carries out a communication process as a server defined by HTTP (Hyper Text Transfer Protocol). The collection analysis unit 512 analyzes video in order to set the collection of tiles to which the common settings pertaining to the difference between quality ranks are to be applied.

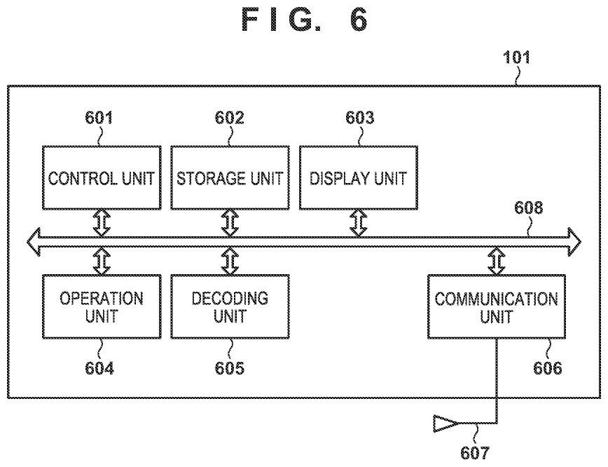

An example of the configuration of the client 101 will be described next. FIG. 6 is a diagram illustrating an example of the hardware configuration of the client 101. The client 101 includes, for example, a control unit 601, a storage unit 602, a display unit 603, an operation unit 604, a decoding unit 605, a communication unit 606, a wireless LAN interface 607, and a system bus 608.

The control unit 601 comprehensively controls the operations of the client 101 by controlling the other constituent elements through the system bus 608, for example. The control unit 601 may be, for example, one or more processors such as a CPU (Central Processing Unit), an ASIC (Application Specific Integrated Circuit), an FPGA (Field Programmable Gate Array), or a DSP (Digital Signal Processor). The storage unit 602 stores and manages various types of data. The storage unit 602 can be memory such as SRAM (Static RAM) or DRAM (Dynamic RAM), a high-capacity storage device such as a hard disk drive, or the like, for example. The display unit 603 is, for example, a liquid crystal panel configured to make various types of displays under the control of the control unit 601. The operation unit 604 is, for example, keys and buttons that accept operations by a user. The display unit 603 and the operation unit 604 may be configured as a single device, as with a touch panel, for example. The decoding unit 605 carries out a process for decoding video. Although the decoding unit 605 may be constituted by a dedicated circuit, the obtained video may be decoded by the control unit 601 executing programs stored in the storage unit 602, for example. The communication unit 606 executes various types of communication processes through the wireless LAN interface 607. The communication unit 606 is configured including communication circuitry such as a modulation/demodulation circuit, for example. The wireless LAN interface 607 in configured to include an RF front end, an antenna, and the like, for example, and converts signals generated by the communication unit 606 into wireless signals and outputs those signals through the antenna. Although the present embodiment describes the communication unit 606 as carrying out communication over a wireless LAN, the communication is not limited thereto, and the communication may be wired communication through a wired LAN interface, other wireless communication such as Bluetooth (registered trademark) public mobile communication, or the like. The client 101 may include a plurality of communication interfaces. Although the present embodiment describes the display unit 603 as a single constituent element of the client 101, an external display device such as a monitor or a television connected over HDMI (registered trademark) or the like may be used, for example. In this case, the client 101 can include a display control unit, for example.

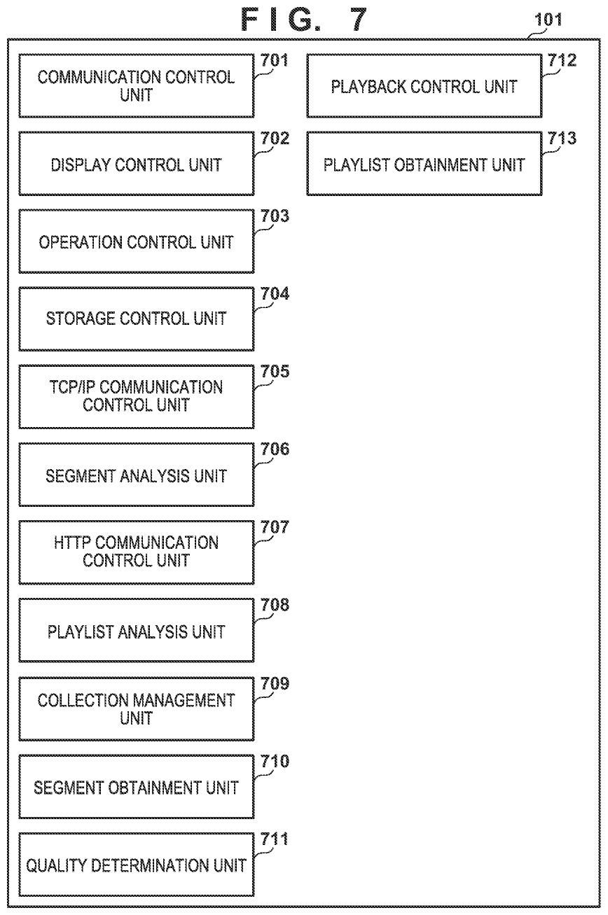

FIG. 7 is a diagram illustrating an example of the functional configuration of the client 101. The client 101 is configured to include, for example, a communication control unit 701, a display control unit 702, an operation control unit 703, a storage control unit 704, a TCP/IP communication control unit 705, an HTTP communication control unit 707, and a playlist obtainment unit 713. The client 101 further includes a segment analysis unit 706, a playlist analysis unit 708, a collection management unit 709, a segment obtainment unit 710, a quality determination unit 711, and a playback control unit 712. The functional units illustrated in FIG. 7 can be realized by, for example, the control unit 601 executing programs stored in the storage unit 602. However, some or all of the functional units, or parts of individual functional units, may be realized by hardware.

The communication control unit 701 controls the communication unit 606 to execute communication. The display control unit 702 controls the display unit 603 to display predetermined information. The display control unit 702 may display video based on data received through the communication unit 606, a UI for accepting user operations, and the like in the display unit 603, for example. The operation control unit 703 controls the operation unit 604 to accept user operations. The storage control unit 704 controls the storage unit 602 to store, change, or delete various types of information such as processing data and videos. The TCP/IP communication control unit 705 uses the communication unit 606 to control TCP/IP communication with the server 102. Although the present embodiment describes an example where TCP/IP communication is used, the communication is not limited thereto, and UDP may be used instead. The segment analysis unit 706 controls the decoding unit 605 to decode the segment, which is the video obtained from the server 102. The HTTP communication control unit 707 carries out a communication process as a client defined in HTTP.

The playlist obtainment unit 713 obtains the playlist from the server 102. The playlist analysis unit 708 analyzes the playlist obtained from the server 102 by the playlist obtainment unit 713. Here, the playlist is assumed to an MPD file. URLs for accessing specific segments at specific timings are written in the MPD file. Information of the collections to which the AdaptationSets corresponding to each tile belong, the identifiers of those collections, information of the settings pertaining to the difference in quality ranks for each collection, and the like are also written in the MPD file. The playlist analysis unit 708 obtains the various types of information, such as the segments, the AdaptationSet collections, the collection identifiers, the information of the settings pertaining to the difference between quality ranks for each collection, and the like through analysis. Although the present embodiment describes an example in which the above-described information is written in an MPD file, the file is not limited thereto, and the information may instead be written in an HTML file, a JavaScript file, or the like. In this case, the playlist analysis unit 708 can obtain the above-described various types of information by analyzing the HTML file or the JavaScript file.

The collection management unit 709 manages the information of the collections of the plurality of AdaptationSets, and the information pertaining to the difference between the quality ranks for each of those collections, obtained as a result of the analysis by the playlist analysis unit 708. The segment obtainment unit 710 accesses the URL from which each segment is to be obtained in accordance with the playlist in the MPD file or the like, and obtains those segments. Although the location of the segments can be the server 102, for example, the location is not limited thereto, and may instead be another server, a camera or the like connected to a network, or the like. The quality determination unit 711 determines a Representation to be obtained on the basis of the information of the difference between the quality ranks managed by the collection management unit 709, for each AdaptationSet collection. “Representation” refers to a video (segment), included in a single AdaptationSet, having a different quality rank for the same tile. The segment obtainment unit 710 accesses the URL of the location of the Representation determined by the quality determination unit 711 among the URLs of the locations of one or more Representations included in each AdaptationSet, and obtains the segment. The playback control unit 712 carries out a process for playing back the video decoded by the segment analysis unit 706. Note that the segment analysis unit 706 or the playback control unit 712 can execute a process for synthesizing the video corresponding to a plurality of separate pixel regions. At this time, if, for example, a plurality of videos have been captured by different cameras, any regions that overlap between the videos are specified and synthesized.

### MPD File Configuration

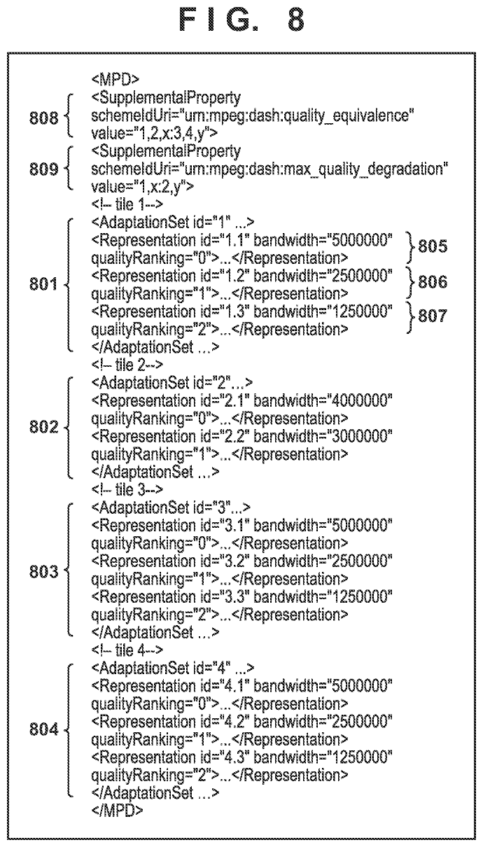

Several examples of the MPD file (playlist) generated by the server 102 will be described next using FIGS. 8 to 11. Although FIGS. 8 to 11 indicate MPD file including items particularly useful for describing the present embodiment, the files may include other items as well. In other words, although the MPD file can include other parameters defined in the standard MPEG-DASH or future extensions thereof, for example, the present embodiment will not describe those other parameters for the sake of simplicity.

### Configuration Example 1

A first example of the configuration of the MPD file will be described first using FIG. 8. FIG. 8 illustrates an example of the MPD file when the tiles have been collected in the manner illustrated in FIG. 2D. Note that the MPD file can be configured in a similar manner even if the tiles have been collected in the manner illustrated in FIG. 2E. In FIG. 8, the information of tiles 1 to 4 is written into AdaptationSet elements 801 to 804, respectively. The AdaptationSet element 801 includes an attribute of “id=1”, indicating the identifier of tile 1. Likewise, the AdaptationSet element 802 includes an attribute of “id=2”, the AdaptationSet element 803 includes an attribute of “id=3”, and the AdaptationSet element 804 includes an attribute of “id=4”. Although the tile identifiers are expressed as numbers here (“1” for the AdaptationSet element 801), the identifiers are not limited thereto, and can instead be expressed as a character string constituted by text that can be used as an identifier as defined by the MPEG-DASH standards, such as alphanumerics, symbols, or the like.

Information pertaining to videos of different qualities for tile 1 is stored in Representation elements 805 to 807, respectively, which are included in the AdaptationSet element 801. The identifier of that element, i.e. “id”, is included as an attribute in each of the Representation elements 805 to 807. The Representation elements 805 to 807 also include “bandwidth”, indicating the bandwidth of the corresponding video, and “qualityRank”, indicating the relative quality rank within the single AdaptationSet element, as attributes. For example, the Representation element 805 includes, as attributes, “id=1.1”, “bandwidth=5000000”, and “qualityRank=0”. Here, the qualityRanking attribute is an attribute in which a lower value thereof for a Representation element indicates that the video corresponding to that Representation element has a higher quality. In the example in FIG. 8, the video corresponding to the Representation element 805 has the highest quality, the video corresponding to the Representation element 806 has the next highest quality, and the video corresponding to the Representation element 807 has the lowest quality. Note that qualityRank indicates the quality rank within a single AdaptationSet element as described above, and does not indicate the quality relationship with videos corresponding to Representation elements included in other AdaptationSet elements.

In FIG. 8, the AdaptationSet element 802 includes two Representation elements. Thus the number of Representations included in an AdaptationSet may differ from AdaptationSet to AdaptationSet. Additionally, as indicated by the AdaptationSet elements 801 and 802, the bandwidth, quality, and the like of the videos specified by the Representation elements included in an AdaptationSet may differ from tile to tile.

In the present embodiment, a SupplementalProperty element 808 is defined to specify an AdaptationSet collection that shares settings pertaining to the difference between quality ranks. The SupplementalProperty element 808 includes a “schemeldUri” attribute. The schemeldUri attribute defines a value “urn:mpeg:dash:quality_equivalence”. For example, a device such as the client 101 can use this value to identify that the SupplementalProperty element 808 is an element defining a collection that shares settings pertaining to the difference between quality ranks (qualityRanking). The SupplementalProperty element 808 includes a “value” attribute, and the collected AdaptationSets are defined by the value attribute. The value “1,2,x:3,4,y” set for the value attribute indicates that a first collection (a first set group) is constituted by AdaptationSets having identifiers of “1” and “2”, and that a second collection (a second set group) is constituted by AdaptationSets having identifiers of “3” and “4”. “x” is the identifier of the first collection, and “y” is the identifier of the second collection. In the present embodiment, the symbol “:” is used to delimit the two collections. In this manner, information associating the identifier of the collection with the identifiers of the AdaptationSets belonging to that collection is written in the SupplementalProperty element 808, in a single section not delimited by the symbol “:”.

Note that these descriptions are merely examples, and any desired descriptions making it possible to specify the identifiers of the first collection and the second collection, and the AdaptationSets belonging to those collections, as described above may be used. For example, the “:” indicating the delimiting of the collections may be replaced with a predetermined symbol that makes it possible to distinguish between the AdaptationSet identifiers and the collection identifiers and that makes it possible for the device that has received the MPD file to recognize the delimiting of the collections. Additionally, the order of the descriptions, i.e., (identifier of AdaptationSet included in collection), (identifier of that collection) may be replaced with another order, such as (identifier of collection), (identifier of AdaptationSet included in that collection). Furthermore, if only one collection is present, the collection identifier may be omitted. Furthermore, the collection identifier is not limited to a character such as “x” or “y”, and may be expressed as a character string of any length constituted by any desired alphanumerics, symbols, or the like.

A SupplementalProperty element 809 is further defined in the MPD file according to the present embodiment in order to make settings pertaining to the difference between quality ranks for each collection. The difference between quality ranks refers to, for example, a difference between the qualityRanking values within Representation elements, which correspond to the videos obtained for the each of the plurality of AdaptationSets belonging to a single collection. Thus, for example, the setting pertaining to the difference between quality ranks can be that the difference between the qualityRanking values, corresponding to the videos obtained for each of the plurality of AdaptationSets belonging to the collection for which that setting is made, is within a predetermined value. Such settings may specify desired factors, in which it is recommended that conditions pertaining to the settings be satisfied, or required factors, in which it is necessary that the conditions pertaining to the settings be satisfied. For example, if the difference between the qualityRanking values corresponding to the plurality of videos obtained within a given collection is recommended to be within a predetermined value, the information of that predetermined value can be designated as the setting information. Information or the like indicating whether the set conditions are recommended or required may be included as well.

In FIG. 8, the SupplementalProperty element 809 has an attribute “schemeIdUri”, and the schemeIdUri attribute defines a value “urn:mpeg:dash:max_quality_degradation”. Using this identifier, the client 101 or the like that has received the MPD file can recognize that the SupplementalProperty element 809 defines settings pertaining to the difference between quality ranks for each collection. Note that settings aside from the settings pertaining to the difference between quality ranks for each collection may also be made, in which case, for example, the “max_quality_degradation” part of the above-described value can be replaced with another character string.

The SupplementalProperty element 809 further includes an attribute “value”, and the settings pertaining to the difference between quality ranks of the videos for each collection are described in the value attribute. The value attribute is written as, for example, “1,x:2,y”. In the present embodiment, the symbol “:” is used to delimit the setting information pertaining to two collections. “x” and “y” are identifiers pertaining to AdaptationSet collections, and identifiers common with the SupplementalProperty element 808 are used. In other words, the AdaptationSet collection is expressed with a common identifier in the first SupplementalProperty element 808 and the second SupplementalProperty element 809. On the other hand, “1” and “2” in the value attribute indicate setting values for the value of the difference between quality ranks for the collection having the identifier x and the collection having the identifier y, respectively. Here, a maximum value recommended for the difference between quality ranks is specified. For example, when, according to the “1,x” part, two videos described in AdaptationSets with “1” and “2” for the ids included in the collection having the identifier x are to be played back simultaneously, a setting is made for recommending that the difference between the quality ranks of the two videos be within “1”. Likewise, when, according to the “2,y” part, two videos described in AdaptationSets with “3” and “4” for the ids included in the collection having the identifier y are to be played back simultaneously, a setting is made for recommending that the difference between the quality ranks of the two videos be within “2”. In this manner, information associating the identifier of the collection with the setting values applied to that collection is written in the SupplementalProperty element 809, in a single section not delimited by the symbol “:”.

For example, assume that the client 101 simultaneously plays back videos obtained on the basis of the +AdaptationSet element 801 and the AdaptationSet element 802. In this case, the difference between the qualityRankings is 0 for the video (segment) having a Representation id of “1.1” and the video having a Representation id of “2.1”. As such, the client 101 can determine that the settings recommended when playing back these videos simultaneously are satisfied. On the other hand, with the client 101, the difference between the qualityRankings is 2 for the video having a Representation id of “1.3” and the video having a Representation id of “2.1”. As such, the client 101 can determine that the settings recommended when playing back these videos simultaneously are not satisfied, i.e., that it is not recommended to play back these videos simultaneously.

The descriptions in the SupplementalProperty element 809 in the above-described example are merely one example, and a different expression having the same intent may be used instead. For example, the “:”, which indicates a delimiter between the settings pertaining to two collections, may be replaced with a predetermined symbol that can be distinguished from the values used for settings, the identifiers of the collections (x, y), and the like, and that makes it possible for the device receiving the MPD file to recognize the delimiter between the collections. Additionally, the order of the descriptions, i.e., (setting value), (identifier of that collection), may be replaced with another order, such as (identifier of collection), (setting value). Furthermore, if only one collection is present, the collection identifier may be omitted.

Note that in the present embodiment, settings pertaining to the difference between quality ranks for a given AdaptationSet collection being shared refers to a benchmark pertaining to the difference between quality ranks of Representations within the AdaptationSet being shared. In other words, in a collection where the settings are shared, when the setting value pertaining to a difference between quality ranks with respect to another AdaptationSet is “1” for a first AdaptationSet, the value is “1” for a second AdaptationSet within the collection as well. In the example of FIG. 8, the AdaptationSet elements 801 and 802, having ids of “1” and “2”, share the settings pertaining to the difference between quality ranks, as indicated by the SupplementalProperty element 808. Accordingly, the setting value pertaining to the difference between quality ranks with respect to another AdaptationSet is “1” for both the AdaptationSet elements 801 and 802, as indicated by the SupplementalProperty element 809. Note that if the settings pertaining to the difference between quality ranks are shared for a given AdaptationSet collection, the settings may be set so that video having the same qualityRanking is obtained for all of the AdaptationSets within the collection.

In this manner, the client 101 can identify a collection of a plurality of AdaptationSets as a result of the server 102 writing the SupplementalProperty element 808 in the MPD file. Additionally, the client can ascertain the settings pertaining to the difference between quality ranks for each AdaptationSet collection as a result of the server 102 writing the SupplementalProperty element 809 in the MPD file. At this time, using the SupplementalProperty elements 808 and 809 to express the identifiers of the collections (the above-described “x” and “y”) using a common identifier makes it possible for the client 101 to easily recognize the relationship between the elements. Using these two pieces of information, the server 102 can communicate, to the client 101, the settings pertaining to the difference between quality ranks used when one of a plurality of videos, each defined by a plurality of AdaptationSets within a single collection, is selected, and the selected videos are played back simultaneously. Using this communicated information, the client 101 can then obtain and play back a recommended combination of videos, for example. Accordingly, the client 101 can play back the video without imparting a sense of unnaturalness on the user due to a difference in qualities between the Representations that are played back simultaneously. The user experience can be improved as a result.

### Configuration Example 2

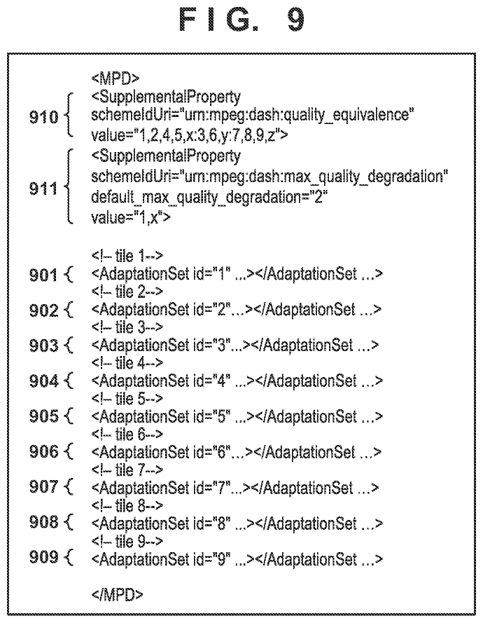

A second example of the configuration of the MPD file will be described next using FIG. 9. FIG. 9 illustrates an example of the MPD file when the tiles have been collected in the manner illustrated in FIG. 2E. It is clear that the configuration of the MPD file illustrated in FIG. 9 can also be used when the tiles are collected as indicated in FIG. 2D. In FIG. 9, the information of tiles 1 to 9 is written into AdaptationSet elements 901 to 909, respectively. Note that the AdaptationSet elements 901 to 909 include one or more Representation elements, in the same manner as the Representation elements 805 to 807 in FIG. 8. However, these descriptions have been omitted from FIGS. 9 to 11 for the sake of simplicity.

The MPD file illustrated in FIG. 9 includes a SupplementalProperty element 910, like the SupplementalProperty element 808 in FIG. 8. For example, a first collection (first set group) having an identifier “x”, constituted by AdaptationSets having ids of “1”, “2”, “4”, and “5”, is defined by the SupplementalProperty element 910. Likewise, a second collection (second set group) having an identifier “y”, constituted by AdaptationSets having ids of “3” and “6”, and a third collection (third set group) having an identifier “z”, constituted by AdaptationSets having ids of “7”, “8”, and “9”, are defined as well.

On the other hand, a SupplementalProperty element 911 is written in the MPD file in FIG. 9, in a different format from the SupplementalProperty element 809 in FIG. 8, as information of the settings pertaining to the difference between quality ranks for each collection. The SupplementalProperty element 911 has the same configuration as the SupplementalProperty element 809 up to the schemeldUri attribute and the description of that value. On the other hand, an attribute “default_max_quality_degradation”, which is not included in the SupplementalProperty element 809, is described in the SupplementalProperty element 911. This default_max_quality_degradation attribute can be defined when the same (default) settings pertaining to the difference between quality ranks are used for one or more collections. In the example of FIG. 9, “2” is set as the value of the default_max_quality_degradation attribute. The description of the value attribute is basically the same as the description of the value attribute in the SupplementalProperty element 809. However, nothing is written in the value attribute for a collection, among the plurality of collections, in which the value of this default_max_quality_degradation attribute is used as the setting pertaining to the difference between quality ranks. In other words, for collections where nothing is written in the value attribute, the value specified by the default_max_quality_degradation attribute is used as the setting pertaining to the difference between quality ranks. An example of FIG. 9, a description is present in the value attribute for the collection having the identifier x, but no description is present in the value attributes for the collections having the identifiers y and z. As such, the value of the setting pertaining to the difference between quality ranks is treated as “2” for the collections having the identifiers y and z. On the other hand, “1,x” is written in the value attribute for the collection having the identifier x, and thus the setting value pertaining to the difference between quality ranks is “1”. In other words, the description “value=‘1,x’” in the SupplementalProperty element 911 has the same meaning as the description “value=‘1,x:d,y:d,z’” in the SupplementalProperty element 809. Here, “d” is the value specified by the default_max_quality_degradation attribute (“2”, in the example of FIG. 9). Likewise, the SupplementalProperty element 911 being “value=‘1,y’” has the same meaning as the SupplementalProperty element 809 being “value=‘d,x:1,y:d,z’”. Note that even if a plurality of collections use the value designated by the same default_max_quality_degradation attribute, the videos are obtained individually in accordance with the settings for each of those plurality of collections. For example, assume that even if the value of the default_max_quality_degradation attribute used in common for the first collection and the second collection is “1”, video having a quality rank of “0” is obtained for the first collection. At this time, if the maximum quality rank is “1” for the video obtained in the second collection, video having a quality rank of “2” in the second collection is within the recommended range. In other words, even if the same settings are used, the selection of the videos for the second collection is made regardless of the quality rank of the videos obtained in the first collection.

In the example of FIG. 9 as well, the identifiers pertaining to the AdaptationSet collections are expressed as a common identifier for the SupplementalProperty elements 910 and 911. Accordingly, the device that has received the MPD file can clearly identify the relationship between the SupplementalProperty element 910 and the SupplementalProperty element 911.

In this manner, when the server 102 defines the settings pertaining to the difference between quality ranks used in common for one or more collections, the amount of the descriptions in the MPD file can be reduced when a plurality of collections use the same settings. Additionally, when the server 102 defines the settings pertaining to the difference between quality ranks used in common for a plurality of collections, it is sufficient for the client 101 to execute the same processing for the plurality of collections, which makes it possible to reduce the processing load on the client 101.

### Configuration Example 3

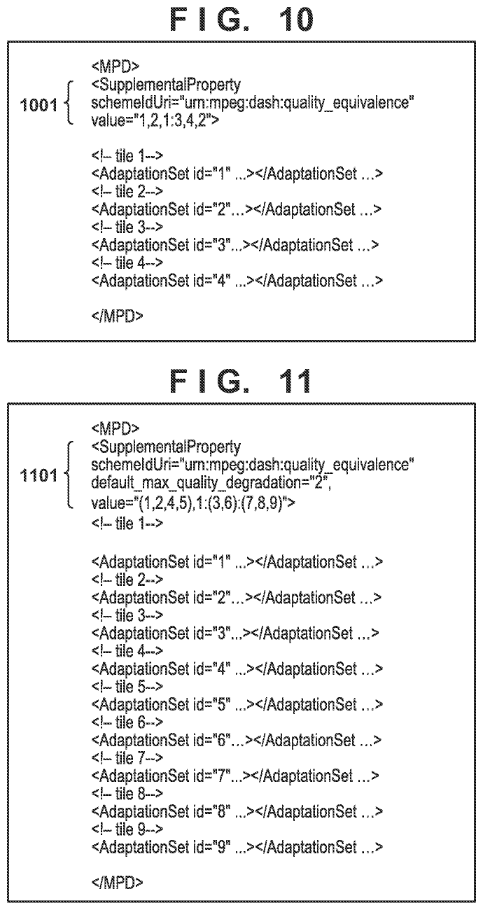

A third example of the configuration of the MPD file will be described next using FIG. 10. FIG. 10 illustrates an example of the MPD file when the tiles have been collected in the manner illustrated in FIG. 2D. The MPD file illustrated in FIG. 10 includes a single SupplementalProperty element 1001 instead of the two SupplementalProperty elements 808 and 809 indicated in FIG. 8. In other words, the AdaptationSet collection, and the settings pertaining to the difference between quality ranks for each collection, are defined by the single SupplementalProperty element 1001.

The SupplementalProperty element 1001 has the same configuration as the SupplementalProperty element 808 with respect to the schemeldUri attribute and the value thereof. On the other hand, the SupplementalProperty element 1001 has a different value from the SupplementalProperty elements 808 and 809 in the value attribute, namely “1,2,1:3,4,2”. Here, the symbol “:” indicates delimiting between the information pertaining to the two collections. In other words, “1, 2, 1” indicates information pertaining to the first collection (the first set group), whereas “3, 4, 2” indicates values pertaining to the second collection (the second set group). Of the information pertaining to a single group, the final value (the value on the right side) is a value indicating the settings pertaining to the difference between quality ranks for that collection, whereas the rest of information indicates the ids of the AdaptationSets belonging to that collection. In other words, “1, 2, 1” indicates that the setting value pertaining to the difference between quality ranks is “1” for the collection constituted by the AdaptationSets having ids of “1” and “2”. Likewise, “3, 4, 2” indicates that the setting value pertaining to the difference between quality ranks is “2” for the collection constituted by the AdaptationSets having ids of “3” and “4”. In other words, the SupplementalProperty element 1001 has the same meaning as the combination of the SupplementalProperty element 808 and the SupplementalProperty element 809 in FIG. 8. Note that the order of the AdaptationSet identifier in the information of the settings pertaining to the difference between quality ranks is not limited to this order, and, for example, the information of the settings pertaining to the difference between quality ranks may come first (on the left side).

In this manner, the amount of descriptions in the MPD file can be reduced by the server 102 writing the identifiers of the AdaptationSets belonging to the collection, and the information pertaining to the settings for the difference between quality ranks in that collection, in a single SupplementalProperty element.

### Configuration Example 4

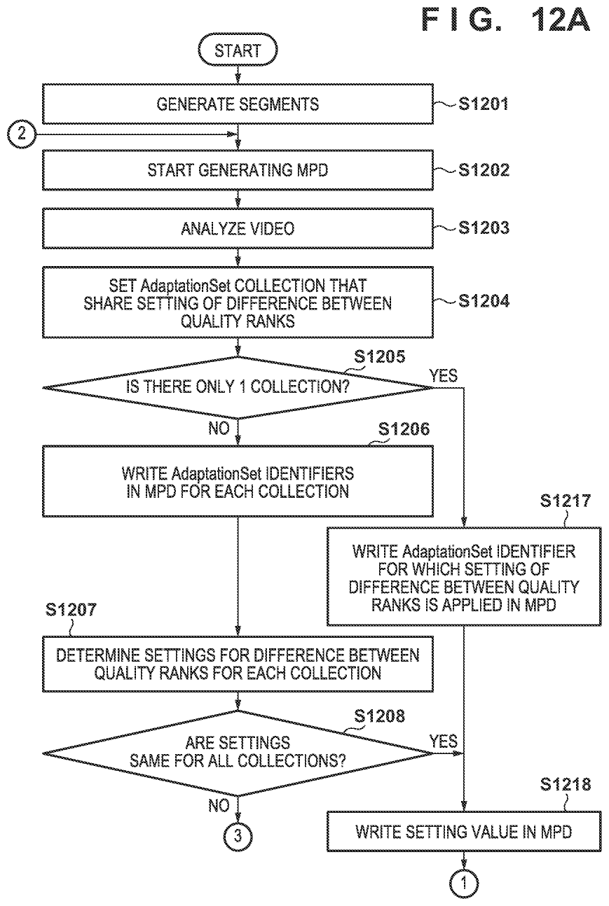

Finally, a fourth example of the configuration of the MPD file will be described using FIG. 11. FIG. 11 illustrates an example of the MPD file when the tiles have been collected in the manner illustrated in FIG. 2E. It is clear that the configuration of the MPD file illustrated in FIG. 11 can also be used when the tiles are collected as indicated in FIG. 2D. The MPD file illustrated in FIG. 11 includes a single SupplementalProperty element 1101 instead of the two SupplementalProperty elements 910 and 911 indicated in FIG. 9. In other words, the AdaptationSet collection, and the settings pertaining to the difference between quality ranks for each collection, are defined by the single SupplementalProperty element 1101.

The SupplementalProperty element 1101 has the same configuration as the SupplementalProperty element 910 with respect to the schemeldUri attribute and the value thereof. The SupplementalProperty element 1101 also has the same configuration as the SupplementalProperty element 911 with respect to the default_max_quality_degradation attribute. On the other hand, the SupplementalProperty element 1101 has a different value from the SupplementalProperty elements 910 and 911 in the value attribute, namely “(1,2,4,5),1:(3,6):(7,8,9)”. Here, the symbol “:” indicates delimiting between the information pertaining to the two collections. This configuration can be said to be a configuration in which the value designated by the default_max_quality_degradation attribute has been omitted from the SupplementalProperty element 1001 in FIG. 10 as the value of the settings pertaining to the difference between quality ranks. In other words, the SupplementalProperty element 1101 has a configuration obtained by combining the SupplementalProperty element 1001 in FIG. 10 with the SupplementalProperty elements 910 and 911 in FIG. 9. With the description in the value attribute, “(1,2,4,5),1” indicates a collection of AdaptationSets having ids of “1”, “2”, and “4” (the first set group), and the value of the settings pertaining to the difference between quality ranks is “1”. On the other hand, “(3,6)” indicates a collection of the AdaptationSets having ids of “3” and “6” (the second set group), and the value of the settings pertaining to the difference between quality ranks is the value specified by the default_max_quality_degradation attribute. Likewise, “(7,8,9)” indicates a collection of the AdaptationSets having ids of “7”, “8”, and “9” (the third set group), and the value of the settings pertaining to the difference between quality ranks is the value specified by the default_max_quality_degradation attribute.

In the SupplementalProperty element 1101, the ids of the AdaptationSets belonging to the collection are enclosed in parentheses (“(” and “)”). This is because, for example, there is a risk that it will not be possible to distinguish whether the “6” in the value “3, 6” is the id of the AdaptationSet or the value of the settings pertaining to the difference between quality ranks. However, the parentheses need not be used if, for example, text is used to make it possible to put a delimiter between the id of the AdaptationSet belonging to the collection and the value of the settings pertaining to the difference between quality ranks. For example, using an expression such as “1,2,4,5@1” makes it possible for the device that has received the MPD file to determine that the collection is a collection of AdaptationSets having ids of “1”, “2”, “4”, and “5”, and that the value of the settings pertaining to the difference between quality ranks is “1”. A different description method may be used for the collection and the value of the settings pertaining to the difference between quality ranks. For example, the order in which the information of the collection and the information of the settings pertaining to the difference between quality ranks is written may be reversed, e.g., by writing the information of the settings pertaining to the difference between quality ranks first (on the left).

In this manner, the amount of descriptions in the MPD file can be reduced by the server 102 writing the identifiers of the AdaptationSets belonging to each collection, and the information pertaining to the settings for the difference between quality ranks in those collection, in a single SupplementalProperty element.

Note that the value of the schemeldUri attribute is not limited to the value “urn:mpeg:dash:quality_equivalence” or the like defined in the present embodiment, and another character string may be used instead. In other words, any desired character string can be used as long as it enables the information to be specified according to the present embodiment to be determined, such as defining a collection of AdaptationSets, defining the information of the settings pertaining to the difference between quality ranks, and the like. Likewise, the names of attributes such as “default_max_quality_degradation”, “value”, and the like may be defined by different character strings that have the same meaning. Furthermore, a character string indicating that settings are not defined, such as “undefined” or the like, may be defined for a situation where the settings pertaining to the difference between quality ranks are not defined. Note that the same identifier may be assigned to collections for which the same settings pertaining to the difference between quality ranks are used. For example, in the SupplementalProperty element 910 indicated in FIG. 9, the value may be defined as “1,2,4,5,x:3,6,y:7,8,9,y”. According to this definition, the collection of the AdaptationSets having ids of “3” and “6” and the collection of the AdaptationSets having ids of “7, 8, 9” can be specified as different collections that nevertheless use the same settings pertaining to the difference between quality ranks. If a single setting pertaining to the difference between quality ranks is defined for all of the collections, it is acceptable to write only the information of the settings pertaining to the difference between quality ranks in the MPD file while omitting the information pertaining to the collections of AdaptationSets.

All of the present embodiment describes an example in which the collection of AdaptationSets sharing the same settings pertaining to the difference between quality ranks is clearly written, the configuration is not limited thereto. For example, the settings pertaining to the difference between quality ranks may be defined individually for each of the AdaptationSets. In this case, in the SupplementalProperty element 808, the value attribute is defined as “1,1:2,1:3,2:4,2” (the SupplementalProperty element 809 is omitted in this case). “1,1” indicates “1” for the setting value pertaining to the difference between quality ranks for the AdaptationSet having an id of “1”. Note that “2,1”, “3,2”, and “4,2” indicate “1”, “2”, and “2”, respectively, for the setting values pertaining to the difference between quality ranks for the AdaptationSets having ids of “2”, “3”, and “4”, respectively. Furthermore, the SupplementalProperty elements, as well as the method for describing the attributes and the identifiers, for the MPD, are not limited to this example. The settings pertaining to the difference between quality ranks for a single AdaptationSet can, for example, use AdaptationSets having the same setting values as a single collection, and apply the same settings to that collection. Additionally, the settings pertaining to the difference between quality ranks for a single AdaptationSet may be settings pertaining to a difference arising between a plurality of videos for the same tile due to changes in time, for example.

Additionally, although a collection of AdaptationSets is defined by a single element in the present embodiment, a SupplementalProperty element may be defined for each AdaptationSet collection. For example, a SupplementalProperty element, which includes information of the settings pertaining to the difference between quality ranks and information specifying the AdaptationSets belonging to that collection, is defined for a single collection of AdaptationSets. For example, the details indicated by the SupplementalProperty elements 808 and 809 in FIG. 8 are expressed by two different SupplementalProperty elements. At this time, the two SupplementalProperty elements relate to a collection to which the AdaptationSets having ids of “1” and “2” belong and collection to which the AdaptationSets having ids of “3” and “4” belong, respectively. These SupplementalProperty elements are expressed as follows, for example.

<SupplementalProperty
schemeIdUri=“urn:mpeg:dash:quality_equivalence” quality_degradation=
“1” value=“1,2”>
<SupplementalProperty schemeIdUri=
“urn:mpeg:dash:quality_equivalence” quality_degradation=
“2” value=“3,4”>

The first element indicates that the setting value pertaining to the difference between quality ranks is “1” for the collection to which the AdaptationSets having ids of “1” and “2” belong. The second element indicates that the setting value pertaining to the difference between quality ranks is “2” for the collection to which the AdaptationSets having ids of “3” and “4” belong. Note that the SupplementalProperty elements, as well as the method for describing the attributes and the identifiers, for the MPD, are not limited to this example.

Furthermore, the elements, identifiers, and attributes are not limited to those defined in the present embodiment, and AdaptationSet collections, setting values pertaining to the difference between quality ranks shared by each collection, information associating the collections with the setting values, and the like may be defined in other elements, identifiers, and attributes. For example, for a Preselection element, settings pertaining to the difference between quality ranks shared by AdaptationSets defined in that element may be defined, and other existing elements, identifiers, and attributes may be used as well. New elements, identifiers, and attributes may be defined as well. For AdaptationSets for which common settings pertaining to the difference between quality ranks are not defined, the value of the setting pertaining to the difference between quality ranks with another Representation may be left undefined. In this case, if, for a given AdaptationSet, settings pertaining to the difference between quality ranks shared with another AdaptationSet are not defined, the client 101 can select any desired Representation. The client 101 may also select the same qualityRanking as another AdaptationSet. A different method may be used as well.

All of the present embodiment describes an example of an MPD in which all AdaptationSets belong to 1 of the collections, the MPD is not limited thereto. For example, it is possible for one or more AdaptationSets to not belong to a collection. This will be described using FIG. 9. For example, the AdaptationSets having ids of “7”, “8”, and “9” do not belong to collections, and are assumed to be independent collections. In this case, the SupplementalProperty element 910 can be configured so as to omit descriptions pertaining to the AdaptationSets having ids of “7”, “8”, and “9”, as indicated below.

<SupplementalProperty schemeIdUri=
“urn:mpeg:dash:quality_equivalence” value=
“1,2,4,5,x:3,6,y”>

Additionally, the SupplementalProperty element 910 may describe AdaptationSets having ids of “7”, “8”, and “9” as being individual collections, as indicated below.

<SupplementalProperty schemeIdUri=
“urn:mpeg:dash:quality_equivalence” value=
“1,2,4,5,x:3,6,y:7,z:8,v;9,w”>

Although the present embodiment defines the settings pertaining to the difference between quality ranks as a difference between the qualityRanking values included in a specific collection of AdaptationSets, the configuration is not limited thereto. For example, the settings pertaining to the difference between quality ranks may be made on the basis of the actual values for the bitrate, resolution, sampling rate, or the like.

### Flow of Processing

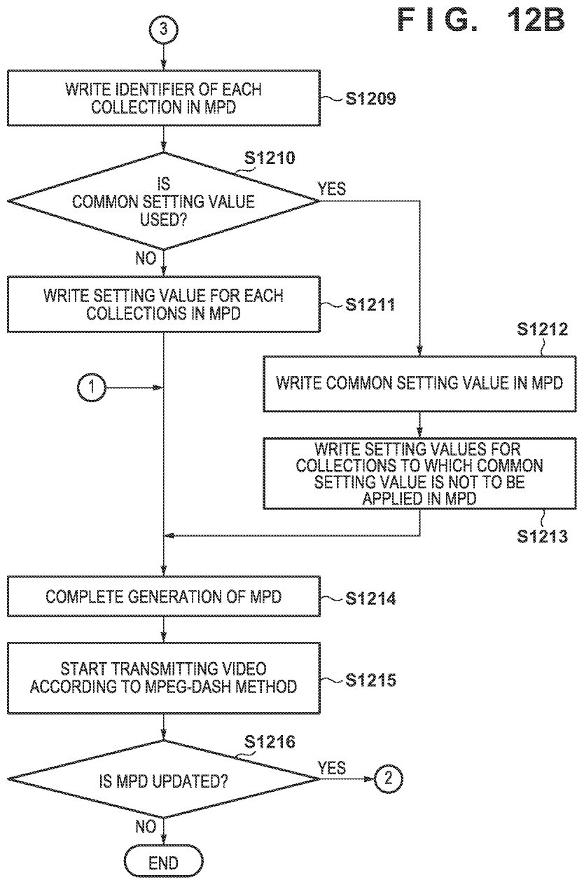

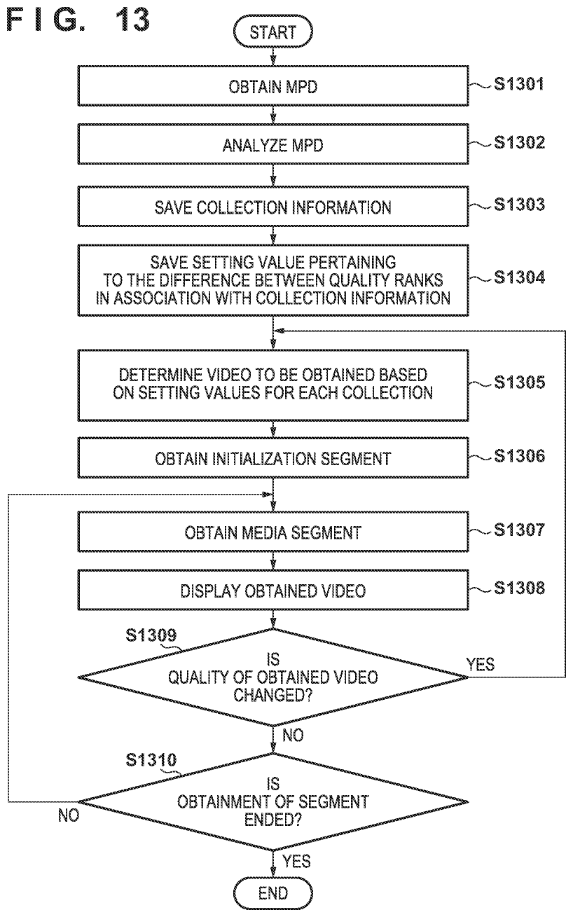

An example of the flow of processing executed by the client 101 and the server 102 according to the present embodiment will be described next. In the following, an example of the flow of processing executed by the server 102 will be described first using FIGS. 12A and 12B, and then an example of the flow of processing executed by the client 101 will be described using FIG. 13.

### Processing of Server 102

First, the segment generation unit 506 generates segments in the MPEG-DASH format (S1201). Here, the segment generation unit 506 generates a plurality of segments having different qualities, and adds quality ranks pertaining to those segments. Note that if the accumulated data is transmitted through a VoD (Video on Demand) technique, the process of S1201 may be omitted, and in this case, segments generated in the past can be used. Note also that if the device from which the video is transmitted is a device different from the server 102, the process of S1201 is not carried out in the server 102, and the segment generation in the adding of the quality ranks of those segments is carried out by the server that transmits the segments, for example.

Next, the playlist generation unit 507 starts generating the MPD (playlist) defined by the MPEG-DASH standard (ISO/IEC23009-1) or an extension of that standard (S1202). As described using FIGS. 8 to 11, a plurality of AdaptationSet elements, storing a plurality of URLs for accessing segments of a plurality of different qualities, are described in the MPD file for each of a plurality of tiles obtained from division. Note that the URLs are written in a format so as to be stored within Representation elements. The information written in the MPD file is not limited to this information, and other information defined by the standard may be written as well. Additionally, the qualityRanking attribute, which indicates the quality rank of the video obtained from the URL within the Representation element, is written within the Representation element. Here, the “quality rank” is a ranking of the level of quality of the videos obtained in accordance with a plurality of Representation elements defined within a single AdaptationSet. The information of the quality rank may be written in an HTML file, a JavaScript file, or the like, aside from the MPD file.

Then, the collection analysis unit 512 analyzes the videos in order to set a collection of AdaptationSets that are to share settings pertaining to the difference between quality ranks (S1203). Note that if information of a collection of tiles is provided in advance, the collection analysis unit 512 may set the collection using that information, and in this case, the video need not be analyzed. On the basis of the analysis result from the collection analysis unit 512, the collection setting unit 508 sets the AdaptationSet collection (S1204). The collection management unit 509 manages the information of the collection set by the collection setting unit 508, i.e., the identifiers of the AdaptationSets included in the collection. The collection management unit 509 defines an identifier for identifying the collection, on a collection-by-collection basis. The playlist generation unit 507 then determines whether or not only one collection is being managed by the collection management unit 509 (S1205).

If it is determined that the collection management unit 509 is managing a plurality of collections (NO in S1205), the playlist generation unit 507 writes information of the identifiers of the AdaptationSets belonging to each of the plurality of collections in the MPD file (S1206). For example, the playlist generation unit 507 defines the SupplementalProperty elements as described using FIGS. 8 to 11, and stores the identifiers of the AdaptationSets belonging to each collection in those elements. The quality difference information determination unit 510 determines the settings for the difference between quality ranks to be used, for each AdaptationSet collection (S1207). The collection management unit 509 manages the settings pertaining to the difference between quality ranks for each of the collections, determined by the quality difference information determination unit 510, in association with the corresponding collections.

The playlist generation unit 507 determines whether the settings pertaining to the difference between quality ranks managed by the collection management unit 509 have the same value for all of the collections (S1208). If it is determined that the settings pertaining to the difference between quality ranks for at least some of the collections are different from other collections (NO in S1208), the playlist generation unit 507 writes the identifier of each collection managed by the collection management unit 509 in the MPD file (S1209). For example, the playlist generation unit 507 stores the identifier of each collection (e.g., “x”, “y”, and “z”) in the SupplementalProperty element as described using FIGS. 8 to 11.

The playlist generation unit 507 determines whether or not a common setting value is used as the setting value pertaining to the difference between quality ranks for the collections managed by the collection management unit 509 (S1210). At this time, the playlist generation unit 507 can determine that the value applied to the most collections, in the settings pertaining to the difference between quality ranks managed by the collection management unit 509, is the common setting value. However, the common setting value may be determined on the basis of a different method. Additionally, by determining whether or not the amount of descriptions in the MPD file will be reduced by using the common setting value, for example, the playlist generation unit 507 can determine whether or not to use the common setting value in this manner. This is only an example, however, and the playlist generation unit 507 may determine whether or not to use the common setting value on the basis of other criteria.

If it is determined that the common setting value is not to be used (NO in S1210), the playlist generation unit 507 writes, in the MPD file, the setting value pertaining to the difference between quality ranks for each of the collections managed by the collection management unit 509 (S1211). For example, the playlist generation unit 507 includes descriptions such as those indicated by the SupplementalProperty element 809 in FIG. 8 and the SupplementalProperty element 1001 in figured 10 in the MPD file.

On the other hand, if it is determined that the common setting value is to be used (YES in S1210), the playlist generation unit 507 writes that common setting value in the MPD file (S1212). The playlist generation unit 507 writes the common setting value in the MPD file as the “default_max_quality_degradation” attribute described with reference to FIGS. 9 and 11, for example. Then, for the collections to which the common setting value is not to be applied, the playlist generation unit 507 writes, in the MPD file, the setting values pertaining to the difference between quality ranks to be applied to those collections (S1213).

Then, the playlist generation unit 507 writes other information, which is necessary for the client 101 to obtain and play back the segments but which is not described in the present embodiment, in the MPD file, and completes the generation of the MPD file (S1214). The server 102 then start transmitting the video, according to the MPEG-DASH format, through the HTTP communication control unit 511 (S1215). Note that if a device aside from the server 102 transmits the video, it is acceptable for the server 102 to transmit only the MPD file to the client 101, without transmitting the video. In this case, the client 101 accesses the device aside from the server 102 in accordance with the MPD file received from the server 102, and obtains the segments corresponding to the tiles.

If the MPEG-DASH live profile is followed, the playlist generation unit 507 determines whether or not to update the MPD file (S1216), and if it is determined that the MPD file is not to be updated (NO in S1216), the process ends. On the other hand, if it is determined that the MPD file is to be updated (YES in S1216), the playlist generation unit 507 returns the process to S1202.

If in S1205 it is determined that the collection management unit 509 manages only a single collection (YES in S1205), the playlist generation unit 507 writes the identifiers of the AdaptationSets belonging to that collection in the MPD file (S1217). In other words, the playlist generation unit 507 writes, in the MPD file, the identifiers of the AdaptationSets in a single collection which shares the settings pertaining to the difference between quality ranks. If the settings pertaining to the difference between quality ranks are to be applied to all AdaptationSets, the playlist generation unit 507 need not carry out the process of S1217. Thereafter, the playlist generation unit 507 writes, in the MPD file, the setting value for the settings pertaining to the difference between quality ranks (S1218). If it is determined that the settings pertaining to the difference between quality ranks are the same for all the collections (YES in S1208), the playlist generation unit 507 writes the setting value of the settings pertaining to the difference between quality ranks in the MPD file, without writing the identifier of each collection in the MPD file (S1218). The process moves to S1214 after the process of S1218.

Note that if the common setting value is not to be used (e.g., when the MPD file is configured as illustrated in FIG. 8 or FIG. 10), the server 102 need not carry out the processes of S1210, S1212, and S1213. In this case, the server 102 moves the process to S1211 after executing the process of S1209. On the other hand, if the common setting value is always to be used (e.g., when the MPD file is configured as illustrated in FIG. 9 or FIG. 11), the server 102 need not carry out the processes of S1210 and S1211. In this case, the server 102 moves the process to S1212 after executing the process of S1209.

Additionally, if the common setting value is defined for all of the AdaptationSets, the server 102 can move the process to S1217 after executing the process of S1203. Furthermore, if the common setting value is defined for all the AdaptationSets without writing the ids of the AdaptationSets, the server 102 may move the process to S1219 after executing the process of S1203.

Note that the processing steps in the flowcharts illustrated in FIGS. 12A and 12B may be replaced with processes having different content from that described here, and the order of the processes may be changed as well. For example, the playlist generation unit 507 may carry out the processes of S1206, S1209, S1211, S1213, and the like, for writing information into the MPD file, all together before the process of S1215, or may carry out those processes at another desired timing Additionally, the processes for analyzing the video and setting the AdaptationSet collection (S1203 and S1204) may be carried out before starting the generation of the MPD file (before the process of S1202), by, for example, being carried out in parallel with the generation of the video segments (S1201).

Additionally, as another example, it is acceptable to execute only the steps indicated by S1201, S1202, S1204, S1206, S1207, S1209, S1211, and S1214. Furthermore, it is acceptable to execute only the steps indicated by S1201 to S1204, S1206, S1209, and S1212 to S1214. It is also acceptable to execute only S1204, S1206, S1207, S1209, and S1211. In this manner, an MPD file having the characteristics according to the present embodiment can be generated even when some of the steps are omitted.

Note that executing the processes of S1205 and S1217 makes it possible to reduce the amount of descriptions in the MPD file when there is only one AdaptationSet collection. Additionally, executing the processes of S1208 and S1218 makes it possible to reduce the amount of descriptions in the MPD file when common settings are applied to all the AdaptationSet collections. Furthermore, executing the processes of S1210, S1212, and S1213 makes it possible to reduce the amount of descriptions in the MPD file by defining the common setting value only once when that common setting value is applied to one or more AdaptationSet collections. These effects make it possible to reduce the processing load on the server 102 and the client 101.

### Processing of Client 101

First, the playlist obtainment unit 713 obtains the MPD file from the server 102 through the HTTP communication control unit 707 (S1301), after which the playlist analysis unit 708 analyzes the obtained MPD file (S1302). The playlist analysis unit 708 obtains information pertaining to the AdaptationSet collections on the basis of the result of analyzing the MPD file, and saves the collection information in the collection management unit 709 (S1303). If, as a result of the playlist analysis unit 708 analyzing the MPD file, it is determined that there is no collection information, the client 101 may obtain the collection information from an HTML file, a JavaScript file, or the like provided from the server 102. On the basis of the result of analyzing the MPD file, the playlist analysis unit 708 obtains the setting value pertaining to the difference between quality ranks for each AdaptationSet collection, and saves that value in the collection management unit 709 in association with the collection information already saved in the collection management unit 709 (S1304). If the playlist analysis unit 708 has determined that a setting value pertaining to the difference between quality ranks is not defined in the MPD file, the client 101 can obtain the setting value from an HTML file, a JavaScript file, or the like provided from the server 102. Additionally, if it is determined that a common setting value is defined for one or more collections, the client 101 may apply that common setting value to collections, among the AdaptationSet collections, for which a setting value is not clearly defined. Note that if the MPD obtained from the server 102 does not include information of the settings pertaining to the difference between quality ranks, the client 101 may define a proprietary setting value on the basis of another value that can be obtained from the MPD, such as the bitrate, resolution, sampling rate, or the like.

The quality determination unit 711 selects the video to be obtained (the Representation including the information pertaining to the video to be obtained) on the basis of the settings pertaining to the difference between quality ranks, for each of the plurality of AdaptationSets (S1305). The segment obtainment unit 710 obtains, from the server 102, an initialization segment and a media segment necessary for playing back the video determined by the quality determination unit 711 (S1306, S1307). The segment analysis unit 706 analyzes the obtained segment and, through the display control unit 702, causes video based on that segment to be displayed in the display unit 603 (S1308).

Then, the quality determination unit 711 determines whether or not to change the quality of the obtained video (tile) (S1309). Note that the timing of the determination as to whether or not to change the quality of the obtained video may be another timing, and the determination can be carried out in any desired timing. For example, the determination may be carried out partway through the process for obtaining the media segment (S1307), partway through the playback process (S1308), or the like. Additionally, this determination can be carried out in response to a user operation, for example, when some or all of the AdaptationSets displayed by the client 101 have been changed. Additionally, if the speed at which the segments are obtained has dropped, the client 101 may determine that there is no extra bandwidth in the network, and may change the quality of the obtained video. Note that this determination may be carried out for each AdaptationSet (each tile). For example, if the speed at which the video is obtained has dropped for some of the tiles, a determination can be made to change the quality of that video. The process of S1309 makes it possible to dynamically change the video being obtained in accordance with changes in the circumstances, such as the bandwidth of the network.

If the quality determination unit 711 determines that the quality of the video being obtained is to be changed (YES in S1309), the process returns to S1305, and it can then be determined whether or not it is necessary to change the quality of the video for another tile on the basis of the stated change and the setting value. If the quality of the video for all of the tiles being obtained is to be changed simultaneously, the client 101 may move the process to S1306, without carrying out the process of S1305. On the other hand, if it is determined that the quality of the video being obtained is not to be changed (NO in S1309), the segment obtainment unit 710 determines whether or not to end the obtainment of the media segments (S1310). If it is determined that the obtainment of the media segments is to be ended (YES in S1310), the client 101 ends the processing, whereas if it is determined that the obtainment of the media segments is not to be ended (NO in S1310), the process returns to S1307.

Note that the processing steps described in the flowchart are not limited to the steps in the order described here. For example, the process of S1305 may be executed after the process for obtaining the initialization segment (S1306), and the determinations of S1309 and S1310 may be carried out in the reverse order. Additionally, it is acceptable for the client 101 to execute only the processes of S1303 to S1305.

Although the AdaptationSet collection information, the identifier of each collection, and the settings pertaining to the difference between quality ranks are written in the MPD file in the present embodiment, the configuration is not limited thereto. For example, some or all of the information may be written in an HTML file, a JavaScript file, or the like, or the information may be obtained dynamically through a JavaScript file. Through this, even a client that lacks the capability to analyze elements, attributes, and the like in the MPD file can obtain the AdaptationSet collection information, the identifier of each collection, and the information of the settings pertaining to the difference between quality ranks for each collection.

Additionally, although the present embodiment describes an example of the video in which a single picture is divided into tiles, the configuration is not limited thereto. For example, the method described above in the present embodiment can be applied even when streaming a plurality of pieces of media data. For example, the method described above in the present embodiment can be applied when a plurality of videos generated by different cameras are arranged in tile form, when synthesizing and playing back a plurality of pieces of audio data, and the like. Additionally, the above-described method can be applied even if the configuration of the AdaptationSet changes partway through the video.

According to the present embodiment as described thus far, the server 102 writes the information of a plurality of AdaptationSet collections, the identifier of each collection, and information of the settings pertaining to the difference between quality ranks for each collection, into the MPD file. By using a combination of these pieces of information, the client 101 can select Representations based on the settings pertaining to the difference between quality ranks, and control the playback, when playing back a plurality of AdaptationSets simultaneously. As a result, a user using the client 101 can view the video without concern for differences in quality between the plurality of videos being played back simultaneously. The user experience can be improved for the user as a result.

According to the present invention, a situation in which differences in quality among a plurality of regions cause an overall video to give the impression of low quality can be prevented in a system that can obtain video at different qualities corresponding to a plurality of regions.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication device that transmits notification information to be referred to by a client to request a video to the client, comprising:
a generating unit configured to generate the notification information, in which a group of sets is expressed using an identifier common in information pertaining to the group of sets, among a plurality of sets including a first set corresponding to a first plurality of videos having different quality ranks and a second set corresponding to a second plurality of videos having different quality ranks, that has common settings pertaining to a difference between the quality ranks, and information indicating settings, for each group of sets, pertaining to a difference between the quality ranks for a plurality of videos to be transmitted to the client; and
a transmitting unit configured to transmit the notification information generated by the generating unit to the client.

2. The communication device according to claim 1, wherein
the information pertaining to the group of sets that has common settings pertaining to the difference between the quality ranks is information in which the common identifier for the group of sets is associated with an identifier of a set belonging to that group of sets.

3. The communication device according to claim 1, wherein
the information indicating the settings for each of group of sets is information associating the common identifier for the group of sets with a value indicating the settings pertaining to the group of sets.

4. The communication device according to claim 1, wherein
in the case where the settings are to be applied in common for a plurality of the groups of sets, the notification information includes a value indicating a common setting that is applied in common; and
the information indicating the settings for each group of sets does not include the common identifier for the groups of sets to which the common setting is applied.

5. The communication device according to claim 4, wherein
the value indicating the common setting is included in information indicating the settings for each group of sets.

6. The communication device according to claim 1, wherein
the information pertaining to the group of sets that share the settings pertaining to the difference between the quality ranks and/or the information indicating the settings for each group of sets is expressed as a character string in which information pertaining to a first group of sets and information pertaining to a second group of sets is delimited by a predetermined symbol.

7. The communication device according to claim 1, wherein
the notification information is an MPEG-DASH Media Presentation Description (MPD) file.

8. The communication device according to claim 7, wherein
the information pertaining to the group of sets that share the settings pertaining to the difference between the quality ranks and the information indicating the settings for each group of sets are included as elements of the MPD.

9. The communication device according to claim 7, wherein:
information indicating each of the plurality of sets are included as a plurality of AdaptationSet elements in the MPD;
in each of the plurality of AdaptationSet elements, information pertaining to each of the plurality of videos for a set corresponding to that AdaptationSet element is included as a plurality of Representation elements; and
the Representation elements include information of attributes pertaining to quality ranks of the videos pertaining to the information included in those Representation elements.

10. A communication device that requests a video, comprising:
a receiving unit configured to receive, from another device, notification information, in which a group of sets is expressed using an identifier common in information pertaining to the group of sets, among a plurality of sets including a first set corresponding to a first plurality of videos having different quality ranks and a second set corresponding to a second plurality of videos having different quality ranks, that has common settings pertaining to a difference between the quality ranks, and information indicating settings, for each group of sets, pertaining to a difference between the quality ranks for a plurality of videos to be transmitted to the communication device; and
an obtainment unit configured to obtain video from one or more of the plurality of sets on the basis of the notification information received by the receiving unit.

11. The communication device according to claim 10, wherein
the information pertaining to the group of sets that has common settings pertaining to the difference between the quality ranks is information in which the common identifier for the group of sets is associated with an identifier of a set belonging to that group of sets.

12. The communication device according to claim 10, wherein
the information indicating the settings for each of group of sets is information associating the common identifier for the group of sets with a value indicating the settings pertaining to the group of sets.

13. The communication device according to claim 10, wherein
in the case where the settings are to be applied in common for a plurality of the groups of sets, the notification information includes a value indicating a common setting that is applied in common; and
the information indicating the settings for each group of sets does not include the common identifier for the groups of sets to which the common setting is applied.

14. The communication device according to claim 13, wherein
the value indicating the common setting is included in information indicating the settings for each group of sets.

15. The communication device according to claim 10, wherein
the information pertaining to the group of sets that share the settings pertaining to the difference between the quality ranks and/or the information indicating the settings for each group of sets is expressed as a character string in which information pertaining to a first group of sets and information pertaining to a second group of sets is delimited by a predetermined symbol.

16. The communication device according to claim 10, wherein
the notification information is an MPEG-DASH Media Presentation Description (MPD) file.

17. The communication device according to claim 16, wherein
the information pertaining to the group of sets that share the settings pertaining to the difference between the quality ranks and the information indicating the settings for each group of sets are included as elements of the MPD.

18. The communication device according to claim 16, wherein:
information indicating each of the plurality of sets are included as a plurality of AdaptationSet elements in the MPD;
in each of the plurality of AdaptationSet elements, information pertaining to each of the plurality of videos for a set corresponding to that AdaptationSet element is included as a plurality of Representation elements; and
the Representation elements include information of attributes pertaining to quality ranks of the videos pertaining to the information included in those Representation elements.

19. A method executed by a communication device that transmits notification information to be referred to by a client to request a video to the client, the method comprising:
generating notification information including at least (i) group information expressing a result of grouping a plurality of sets including a first set corresponding to a first plurality of videos having different quality ranks and a second set corresponding to a second plurality of videos having different quality ranks, and (ii) quality difference information in which information pertaining to a difference between quality ranks recommended to the client is expressed for each of a plurality of groups in accordance with the group information; and
transmitting the generated notification information to the client.

20. A method executed by a communication device that requests a video, the method comprising:
receiving, from another devices, notification information including at least (i) group information expressing a result of grouping a plurality of sets including a first set corresponding to a first plurality of videos having different quality ranks and a second set corresponding to a second plurality of videos having different quality ranks, and (ii) quality difference information in which information pertaining to a difference between quality ranks recommended to a client is expressed for each of a plurality of groups in accordance with the group information; and
obtaining video from one or more of the plurality of sets on the basis of the received notification information.
